(19) United States
(12) Patent Application Publication
(10) Pub. No.: US 2009/0174710 A1
(43) Pub. Date: Jul. 9, 2009

(54) Modeling method and apparatus

(75) Inventors: Jae-young Sim, Yongin-si (KR); Do-kyoon Kim, Seongnam-si (KR); Kee-chang Lee, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/216,248

(22) Filed: Jul. 1, 2008

(30) Foreign Application Priority Data
Jan. 8, 2008 (KR) 10-2008-0002338

(51) Int. Cl. G06T 7/60; G06K 9/46

(52) U.S. Cl. 345/420; 382/199

(57) ABSTRACT

A modeling method and apparatus are provided, in which a vertex for each pixel of a depth image representing an object, the vertex having a 3-D position corresponding to the depth value of each pixel, is generated, grouping is performed on pixels which belong to a non-boundary of the object, among the pixels of the depth image, so that each pixel in the non-boundary of the object and adjacent pixels of the pixel are grouped into one group, and a polygonal mesh that is a set of at least one polygon is generated by connecting the vertices in consideration of the results of grouping.

### CROSS-REFERENCE TO RELATED APPLICATIONS

This application claims the benefit of Korean Patent Application No. 10-2008-0002338, filed on Jan. 8, 2008, in the Korean Intellectual Property Office, the disclosure of which is incorporated herein in its entirety by reference.

### BACKGROUND

1. Field

One or more embodiments of the present invention relate to modeling, and more particularly, to a modeling method and apparatus for representing a model as a polygonal mesh.

2. Description of the Related Art

A depth camera radiates infrared light onto an object when a shot button on the depth camera is operated, calculates a depth value of each point of the object based on the duration of time from a point of time at which the infrared light is radiated to a point of time at which the infrared light reflected from the point is sensed, and expresses the calculated depth values as an image, thereby generating and acquiring a depth image representing the object. Here, depth value means the distance from the depth camera to a point on the object.

In this way, each pixel of the depth image has information on its position in the depth image and a depth value. In other words, each pixel of the depth image has 3-dimensional (3-D) information. Thus, a modeling method is required for acquiring a realistic 3-D shape of an object from a depth image.

### SUMMARY

One or more embodiments of the present invention provide a modeling method for acquiring a realistic 3-dimensional (3-D) shape of an object from a depth image.

One or more embodiments of the present invention provide a modeling apparatus for acquiring a realistic 3-D shape of an object from a depth image.

One or more embodiments of the present invention provide a computer readable recording medium having embodied thereon a computer program for acquiring a realistic 3-D shape of an object from a depth image.

Additional aspects and/or advantages will be set forth in part in the description which follows and, in part, will be apparent from the description, or may be learned by practice of the invention.

According to an aspect of the present invention, a modeling method is provided. The modeling method includes: generating a vertex for each pixel of a depth image representing an object, the vertex having a 3-D position corresponding to the depth value of each pixel; performing grouping on pixels which belong to a non-boundary of the object, among the pixels of the depth image, so that each pixel in the non-boundary of the object and adjacent pixels of the pixel are grouped into one group; and generating a polygonal mesh that is a set of at least one polygon by connecting the vertices in consideration of the results of grouping.

According to another aspect of the present invention, a modeling apparatus is provided. The modeling apparatus includes: a geometry information generation unit generating a vertex for each pixel of a depth image representing an object, the vertex having a 3-D position corresponding to the depth value of each pixel; a connectivity information generation unit performing grouping on pixels which belong to a non-boundary of the object, among the pixels of the depth image, so that each pixel in the non-boundary of the object and adjacent pixels of the pixel are grouped into one group; and a mesh generation unit generating a polygonal mesh that is a set of at least one polygon by connecting the vertices in consideration of the results of grouping.

According to another aspect of the present invention, a computer readable recording medium having embodied thereon a computer program for the modeling method is provided. The modeling method includes: generating a vertex for each pixel of a depth image representing an object, the vertex having a 3-D position corresponding to the depth value of each pixel; performing grouping on pixels which belong to a non-boundary of the object, among the pixels of the depth image, so that each pixel in the non-boundary of the object and adjacent pixels of the pixel are grouped into one group; and generating a polygonal mesh that is a set of at least one polygon by connecting the vertices in consideration of the results of grouping.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates a modeling apparatus, according to an embodiment of the present invention;

FIG. 2 illustrates a connectivity information generation unit in FIG. 1;

FIGS. 3A through 3E explain the operation of a boundary detection unit in FIG. 2;

FIGS. 4A and 4B explain the operation of a grouping unit in FIG. 2 and a mesh generation unit in FIG. 1;

FIG. 5 explains the updating of 3-dimensional meshes generated by the mesh generation unit in FIG. 1; and

FIG. 6 illustrates a modeling method according to an embodiment of the present invention,

### DETAILED DESCRIPTION OF EMBODIMENTS

Reference will now be made in detail to embodiments, examples of which are illustrated in the accompanying drawings, wherein like reference numerals refer to the like elements throughout. Embodiments are described below to explain the present invention by referring to the figures.

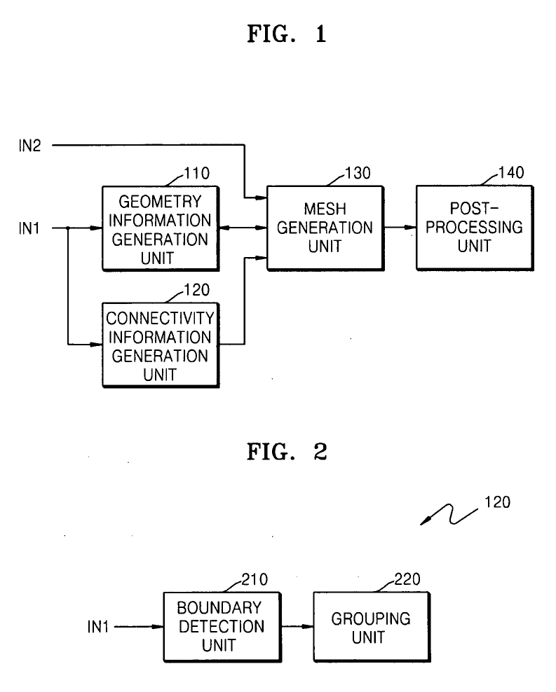

FIG. 1 illustrates a modeling apparatus, according to an embodiment of the present invention, which may include, for example, a geometry information generation unit 110, a connectivity information generation unit 120, a mesh generation unit 130, and a post-processing unit 140.

The geometry information generation unit 110 generates a vertex for each pixel of a depth image input through an input port IN 1. Here, the vertex has a 3-dimensional (3-D) position corresponding to the depth value of each pixel. In particular, the geometry information generation unit 110 generates, for each pixel of the depth image, a vertex having a 3-D position corresponding to the depth value of the pixel and the position of the pixel in the depth image.

The connectivity information generation unit 120 performs grouping on pixels which belong to the non-boundary of the object represented in the depth image input through an input port IN1 so that each pixel in the non-boundary of the object and adjacent pixels of the pixel are grouped into one group.

In particular, the connectivity information generation unit 120 detects the boundary of the object represented in the depth image, among the pixels of the depth image, and performs grouping on the pixels which do not belong to the detected boundary so that each pixel in the non-boundary of the object and pixels adjacent to each non-boundary pixel are grouped into one group. When adjacent pixels of a pixel which belongs to the non-boundary of the object are pixels belonging to the non-boundary of the object, the connectivity information generation unit 120 may group the pixel belonging to the non-boundary of the object and the adjacent pixels of the pixel into one group.

The mesh generation unit 130 generates a polygonal mesh that is a set of at least one polygon by connecting the vertices generated by the geometry information generation unit 110 in consideration of the results of grouping by the connectivity information generation unit 120. In particular, the mesh generation unit 130 generates a polygon by connecting the vertices corresponding to the pixels grouped into the same group. This mesh generation unit 130 generates a polygonal mesh that is a set of at least one polygon by performing this operation on a plurality of vertices. For example, when the pixels of the depth image includes pixels α, β, and γ, which all belong to the non-boundary of the object represented in the depth image, and the pixels α, β, and γ are grouped into the same group by the connectivity information generation unit 120, the mesh generation unit 130 generates a polygon by connecting vertex α′ corresponding to the pixel α, vertex β′ corresponding to the pixel β, and vertex γ′ corresponding to the pixel γ. Here, the generated polygon is a 3-D polygon.

In addition, after the mesh generation unit 130 generates the polygon mesh by connecting the vertices generated by the geometry information generation unit 110 in consideration of the results of grouping by the connectivity information generation unit 120, the geometry information generation unit 110 and the mesh generation unit 130 may additionally perform the following operations.

First of all, the geometry information generation unit 110 calculates a difference in depth value between every two connected vertices generated by itself and checks whether the calculated difference is greater than or equal to a predetermined threshold value. The geometry information generation unit 110 may selectively generate a vertex between the two connected vertices according to the checked results. Here, a difference in depth value between the adjacent vertices among the two connected vertices and the selectively generated vertex is smaller than the predetermined threshold value.

In particular, if it is checked that the difference in depth value between any two connected vertices is smaller than the predetermined threshold value, the geometry information generation unit 110 does not generate a vertex between the two connected vertices. Meanwhile, if it is checked that the difference in depth value between any two connected vertices is greater than or equal to the predetermined threshold value, the geometry information generation unit 110 may additionally generate a vertex between the two connected vertices. Here, the difference in depth value between the adjacent vertices among the two connected vertices and the additionally generated vertex is smaller than the predetermined threshold value.

In addition, the mesh generation unit 130 may update the polygonal mesh generated by itself in consideration of the selectively generated vertex. In particular, the mesh generation unit 130 may divide at least part of the polygons generated by itself in consideration of at least one of the selectively generated vertices.

Meanwhile, the mesh generation unit 130 may receive a color image through an input port IN2. Here, the depth image input through the input port IN1 and the color image input through the input port IN1 match each other. Thus, for each depth pixel making up the depth image input through the input port IN1, the mesh generation unit 130 checks whether there is a color pixel corresponding to the depth pixel, among the color pixels making up the color image input through the input port IN2. If there is such a color pixel, the mesh generation unit 130 recognizes that color pixel. Here, a depth pixel means a pixel which belongs to the depth image input through the input port IN1, and a color pixel means a pixel which belongs to the color image input through the input port IN2. Throughout the specification, for the convenience of explanation, it is assumed that the depth image input through the input port IN1 has M depth pixels in each row and N depth pixels in each column, where M and N are natural numbers greater than or equal to 2, and that the color image input through the input port IN2 has M color pixels in each row and N color pixels in each column. In addition, it is assumed that a depth pixel located in an intersection of an m^{th} row and an n^{th} column of the depth image, where m and n are integers, 1≦m≦M, and 1≦n≦N, matches to a color pixel located in an intersection of the m^{th} row and the n^{th} column of the color image.

When the mesh generation unit 130 receives the color image through the input port IN2, the mesh generation unit 130 can determine the color information of each vertex generated to correspond to the depth image input through the input port IN1 in consideration of the color image. For example, the mesh generation unit 130 can assign color information of one of the color pixels of the color image to each vertex. In this specification, the color information can be expressed by three components, e.g., red (R) component, green (G) component, and blue (B) component.

After the operation of the geometry information generation unit 110 on the depth image, the operation of the connectivity information generation unit 120 on the depth image, and the operation of the mesh generation unit 130 on the vertices corresponding to the depth image have been completed, the post-processing unit 140 may interpolate at least one of color information and geometry information for a hole that is located in the polygonal mesh generated by the mesh generation unit 130 to correspond to the boundary of the object represented in the depth image, in consideration of at least one of color information and geometry information around the hole. Here, geometry information means information on a 3-D shape. Also, the hole means a 3-D space in the 3-D shape expressed by the polygonal mesh generated by the mesh generation unit 130 and where neither color information nor geometry information exist.

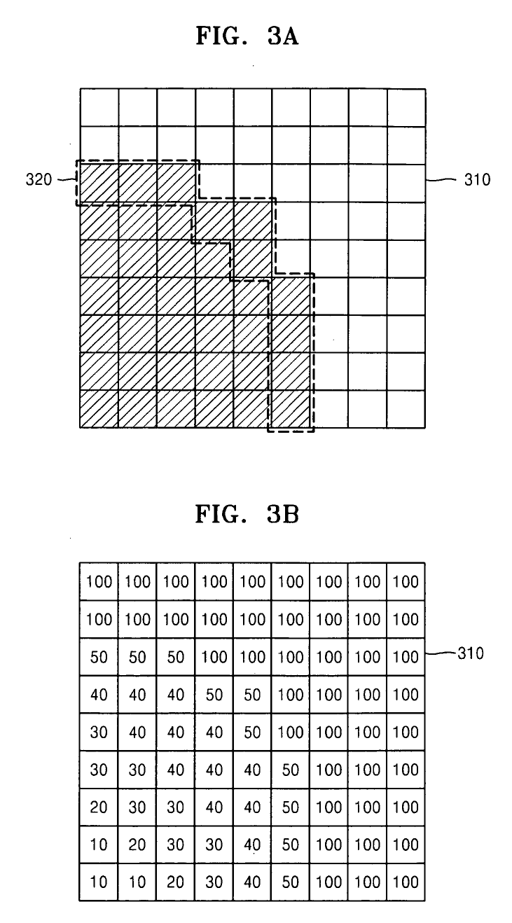

FIG. 2 illustrates the connectivity information generation unit 120 in FIG. 1, which may include a boundary detection unit 210 and a grouping unit 220.

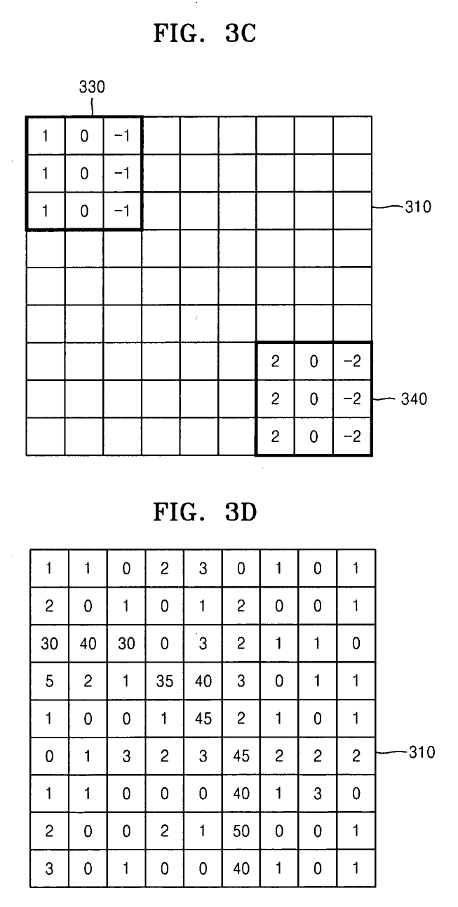

The boundary detection unit 210 detects the boundary of the object represented in the depth image input through the input port IN1. In particular, the boundary detection unit 210 detects the boundary of the object in consideration of the depth value of each pixel of the depth image. Still further, the boundary detection unit 210 filters the depth value of each pixel of the depth image and detects the pixels which belong to the boundary of the object in consideration of the filtered results. Here, the filtering method used by the boundary detection unit 210 may vary. An example of the filtering method will be described with reference to FIGS. 3A through 3E.

The grouping unit 220 performs grouping on the pixels that do not belong to the detected boundary, among the pixels of the depth image, so that each of the pixels not belonging to the detected boundary of the object and pixels adjacent to each of the pixels are grouped into one group.

FIGS. 3A through 3E explain the operation of the boundary detection unit in FIG. 2.

A depth image 310 in FIG. 3A, which is an example of the depth image described throughout this specification, is made up of 81 pixels. In FIG. 3A, a part with oblique lines represents the object represented in the depth image 310. Reference numeral 320 represents the boundary (or more accurately, the pixels belonging to the boundary) of the object.

FIG. 3B shows an example of depth values of the pixels of the depth image 310. As shown in FIG. 3B, the depth value of each pixel that belongs to the background of the object is 100, and the depth values of the pixels that belong to the object vary from 10 to 50.

FIG. 3C explains a filter to be used to detect the boundary of the object. The boundary detection unit 110 may filter the depth value of each pixel of the depth image 310 by adding the results of multiplying the depth values of each pixel and adjacent pixels by a specific filter coefficient. Here, the specific filter coefficient may be arbitrarily set by the user.

Reference numeral 330 represents a filter used to filter the depth value of a pixel located at (i, j)=(2, 2) among the pixels of the depth image 310. Reference numeral 340 represents a filter used to filter the depth value of a pixel located at (i, j)=(8, 8) among the pixels of the depth image 310. Here, i represents the index of a row, and j represents the index of a column. In other words, the position of a pixel located in the left uppermost portion of the depth image 310 is (i, j)=(1, 1), and the position of a pixel located in the right lowermost portion of the depth image 310 is (i, j)=(9, 9).

When the boundary detection unit 210 filters a depth value of 100 of the pixel located at (i, j)=(2, 2) using filter coefficients (1, 1, 1, 0, 0, 0, −1, −1, −1) of the filter 330, the depth value of 100 of the pixel is corrected to (1*100)+(1*100)+(1*50)+(0*100)+(0*100)+(0*50)+(−1*100)+(−1*100)+(−1*50), which is equal to 0. Likewise, when the boundary detection unit 210 filters a depth value of 100 of the pixel located at (i, j)=(8, 8) using filter coefficients (2, 2, 2, 0, 0, 0, −2, −2, −2) of the filter 340, the depth value of 100 of the pixel is corrected to (2*100)+(2*100)+(2*100)+(0*100)+(0*100)+(0*100)+(−2*100)+(−2*100)+(−2*100), which is equal to 0. Under this principle, the boundary detection unit 210 can filter all the depth values of the pixels located at from (i, j)=(1, 1) to (i, j)=(9, 9). Here, filtering on the depth value of a pixel located at (i, j)=(1, 1) is performed with the assumption that depth images that are the same as the depth image 310 exist on the left, left-upper, and upper of the depth image 310. Similarly, filtering on the depth value of a pixel located at (i, j)=(1, 9) is performed with the assumption that depth images that are the same as the depth image 310 exist on the right, right-upper, and upper of the depth image 310. Similarly, filtering on the depth value of a pixel located at (i, j)=(9, 1) is performed with the assumption that depth images that are the same as the depth image 310 exist on the left, left-lower, and lower of the depth image 310. In addition, filtering on the depth value of a pixel located at (i, j)=(9, 9) is performed with the assumption that depth images that are the same as the depth image 310 exist on the right, right-lower, and lower of the depth image 310. In a similar logic, filtering on the depth values of the pixels located at (i, j)=(1, 2), (1, 3), (1, 4), (1, 5), (1, 6), (1, 7), (1, 8) may be performed with the assumption that a depth image that is the same as the depth image 310 exists on the upper of the depth image 310. Similarly, filtering on the depth values of the pixels located at (i, j)=(2, 1), (3, 1), (4, 1), (5, 1), (6, 1), (7, 1), (8, 1) may be performed with the assumption that a depth image that is the same as the depth image 310 exists on the left of the depth image 310. Similarly, filtering on the depth values of the pixels located at (i, j)=(9, 2), (9, 3), (9, 4), (9, 5), (9, 6), (9, 7), (9, 8) may be performed with the assumption that a depth image that is the same as the depth image 310 exists on the lower of the depth image 310. In addition, filtering on the depth values of the pixels located at (i, j)=(2, 9), (3, 9), (4, 9), (5, 9), (6, 9), (7, 9), (8, 9) may be performed with the assumption that a depth image that is the same as the depth image 310 exists on the right of the depth image 310.

FIG. 3D shows an example of the results of filtering the depth values in FIG. 3B. The boundary detection unit 210 determines, from among the 81 filtered results in FIG. 3D, that the pixels with higher values as a result of the filtering are the pixels that belong to the boundary of the object. Here, the criteria for determining whether a value obtained as a result of filtering is high or low may be predetermined. In particular, the boundary detection unit 210 compares each of the filtered results and a predetermined value of, for example, 10, and detects a pixel having a value greater than the predetermined value as the filtered result, among the pixels of the depth image 310, as a pixel that belong to the boundary of the object. In FIG. 3E, pixels with oblique lines represent the pixels detected as the boundary of the object.

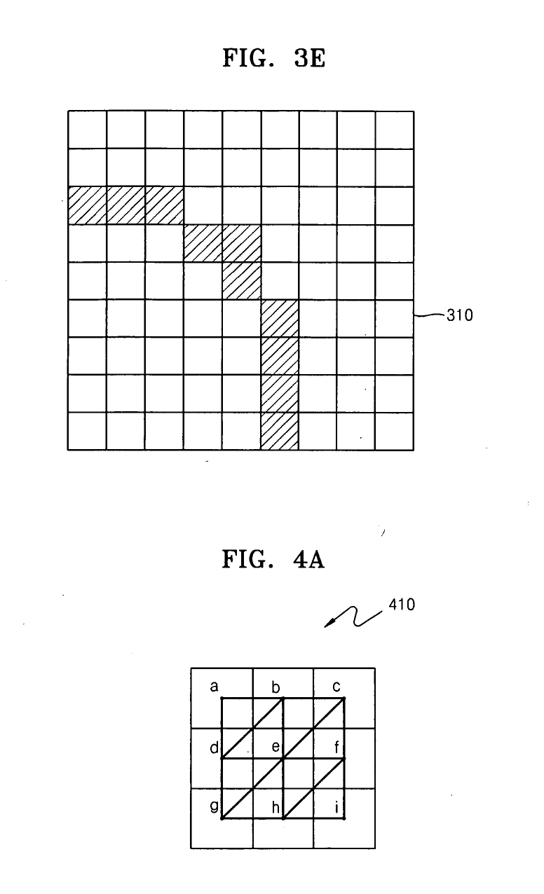

FIGS. 4A and 4B explain the operation of the grouping unit 220 in FIG. 2 and the mesh generation unit 130 in FIG. 1.

A depth image 410 in FIG. 4A, which is another example of the depth image described throughout this specification, consists of 9 pixels, all of which belong to the object represented in the depth image 410.

In FIG. 4A, the grouping unit 220 groups the pixels that belong to the non-boundary of the object into groups of three. The grouping unit 220 generates 8 groups by grouping each pixel of the depth image 410 and pixels adjacent to the pixel into one group. In other words, the grouping unit 220 generates 8 groups, which include a group including pixels a, b, and d, a group including pixels b, d, and e, a group including pixels b, c, and e, a group including pixels c, e and f, a group including pixels d, e, and g, a group including pixels e, g, and h, a group including pixels e, f, and h, and a group including pixels f, h, and l.

As shown in FIG. 4B, the mesh generation unit 130 generates a polygonal mesh that is a set of triangles by connecting the vertices 420 corresponding to the pixels of the depth image 410 in consideration of the groups shown in FIG. 4A. In other words, the mesh generation unit 130 generates 8 triangles by connecting the vertices corresponding to the pixels of the depth image 140 by three. In particular, the mesh generation unit 130 generates a triangle by connecting vertices A, B and C, another triangle by connecting vertices B, D and E, another triangle by connecting vertices B, C and E, another triangle by connecting vertices C, E and F, another triangle by connecting vertices D, E and G, another triangle by connecting vertices E, G and H, another triangle by connecting vertices E, F and H, and another triangle by connecting vertices F, H and I. Here, the vertices A, B, C, D, E, F, G, H, and I correspond to the pixels a, b, c, d, e, f, g, h, and i, respectively. Each triangle in FIG. 4B is a 3-D triangle.

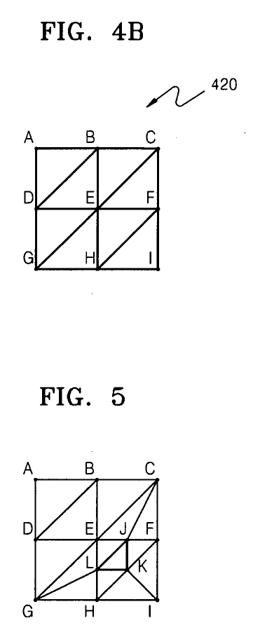

FIG. 5 explains the updating of 3-D meshes generated by the mesh generation unit 130 in FIG. 1.

After the mesh generation unit 130 generates the polygonal mesh in FIG. 4B, the geometry information generation unit 110 checks whether a difference in depth value between every two connected vertices is greater than or equal to a predetermined threshold value. Here, the two connected vertices may be vertices A and B, vertices B and C, vertices A and D, vertices D and G, vertices C and F, vertices F and I, vertices G and H, vertices H and I, vertices B and D, vertices C and E, vertices E and G, and vertices F and H.

In FIG. 5, a difference in depth value between vertices E and F, a difference in depth value between vertices E and H, and a difference in depth value between vertices F and H are each greater than or equal to the threshold value. Thus, since the geometry information generation unit 110 determines the difference in depth value between vertices E and F is greater than or equal to the threshold value, the geometry information generation unit 110 additionally generates vertex J between vertices E and F so that the differences in depth value between vertices E and J and between vertices J and F are smaller than the threshold value. In addition, since the geometry information generation unit 110 determines the difference in depth value between vertices E and H is greater than or equal to the threshold value, the geometry information generation unit 110 additionally generates vertex L between vertices E and H so that the differences in depth value between vertices E and L and between vertices L and H are smaller than the threshold value. Thus, since the geometry information generation unit 110 determines the difference in depth value between vertices F and H is greater than or equal to the threshold value, the geometry information generation unit 110 additionally generates vertex K between vertices F and H so that the differences in depth value between vertices F and K and between vertices K and H are smaller than the threshold value.

Next, the mesh generation unit 130 updates the polygonal mesh in FIG. 4B in consideration of vertices J, L and K. In particular, the mesh generation unit 130 divides at least part of the polygons in FIG. 4B in consideration of vertices J, L and K, as shown in FIG. 5. In other words, as shown in FIG. 5, the mesh generation unit 130 divides a triangle formed by vertices C, E and F being connected to one another into two triangles, e.g., a triangle formed by vertices C, E and J being connected to one another and a triangle formed by vertices C, J and F being connected to one another, by connecting vertices C and J. The mesh generation unit 130 divides a triangle formed by vertices E, G and H being connected to one another into two triangles, e.g., a triangle formed by vertices E, G and L being connected to one another and a triangle formed by vertices L, G and H being connected to one another, by connecting vertices G and L. In addition, the mesh generation unit 130 divides a triangle formed by vertices F, H and I being connected to one another into two triangles, e.g., a triangle formed by vertices F, K and I being connected to one another and a triangle formed by vertices K, H and I being connected to one another, by connecting vertices I and K. Furthermore, the mesh generation unit 130 divides a triangle formed by vertices E, F and H being connected to one another into four triangles, e.g., a triangle formed by vertices E, J and L being connected to one another, a triangle formed by vertices J, K and F being connected to one another, and a triangle formed by vertices J, L and K being connected to one another, by connecting vertices J and L, vertices L and K, and vertices J and K.

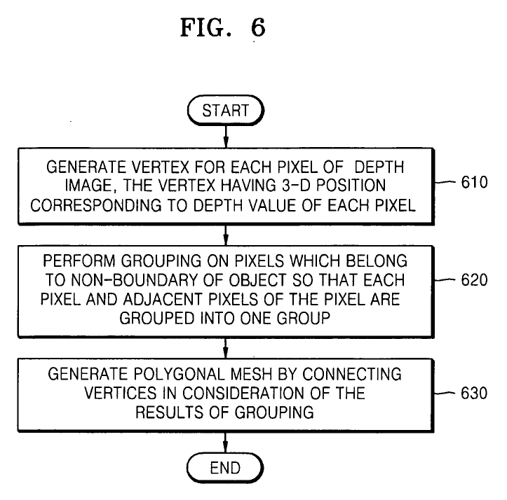

FIG. 6 illustrates a modeling method, according to an embodiment of the present invention. The method in FIG. 6 includes, as an example, operations 610 through 630 for acquiring a realistic 3-D shape of an object represented in a depth image using the depth image. The method of FIG. 6 will be described with reference to FIG. 1.

The geometry information generation unit 110 generates a vertex for each pixel of the depth image, the vertex having a 3-D position corresponding to the depth value of each pixel (operation 610).

After operation 610, the connectivity information generation unit 120 performs grouping on the pixels that belong to the non-boundary of the object, among the pixels of the depth image, so that each pixel in the non-boundary of the object and adjacent pixels of the pixel are grouped into one group (operation 620).

After operation 620, the mesh generation unit 130 generates a polygonal mesh that is a set of at least one polygon by connecting the vertices generated in operation 610 in consideration of the results of grouping in operation 620 (operation 630).

Embodiments of the present invention can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing embodiments may be recorded on any computer-readable media including computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A modeling method comprising:
(a) generating a vertex for each pixel of a depth image representing an object, the vertex having a 3-D position corresponding to the depth value of each pixel;
(b) performing grouping on pixels which belong to a non-boundary of the object, among the pixels of the depth image, so that each pixel in the non-boundary of the object and adjacent pixels of the pixel are grouped into one group; and
(c) generating a polygonal mesh that is a set of at least one polygon by connecting the vertices generated in (a) in consideration of the results of grouping in (b).

2. The modeling method of claim 1, wherein (b) comprises:
detecting a boundary of the object; and
performing grouping on pixels which do not belong to the detected boundary of the object, among the pixels of the depth image, so that each pixel not belonging to the detected boundary of the object and adjacent pixels of the pixel are grouped into one group; and

3. The modeling method of claim 1, wherein, in (c), one polygon is generated by connecting the vertices corresponding to the pixels grouped into one group.

4. The modeling method of claim 1, further comprising:
checking whether a difference in depth value between the connected vertices is greater than or equal to a predetermined threshold value and selectively generating a vertex between the connected vertices according to the checked results; and
updating the polygonal mesh in consideration of the selectively generated vertex.

5. The modeling method of claim 4, wherein a difference in depth value between the connected vertices and the selectively generated vertex is smaller than the threshold value.

6. The modeling method of claim 4, wherein, in the updating, at least part of the polygons is divided in consideration of the selectively generated vertex.

7. The modeling method of claim 1, further comprising determining color information of each vertex in consideration of a color image that matches to the depth image.

8. The modeling method of claim 1, further comprising interpolating at least one of color information and geometry information for a hole that is located in the polygonal mesh to correspond to the boundary of the object, in consideration of at least one of color information and geometry information around the hole.

9. The modeling method of claim 1, wherein the adjacent pixels belong to a non-boundary of the object.

10. The modeling method of claim 1, wherein, in (b), the pixels are grouped by three, and each polygon is a triangle.

11. A modeling apparatus comprising:
a geometry information generation unit generating a vertex for each pixel of a depth image representing an object, the vertex having a 3-D position corresponding to the depth value of each pixel;
a connectivity information generation unit performing grouping on pixels which belong to a non-boundary of the object, among the pixels of the depth image, so that each pixel in the non-boundary of the project and adjacent pixels of the pixel are grouped into one group; and
a mesh generation unit generating a polygonal mesh that is a set of at least one polygon by connecting the vertices in consideration of the results of grouping.

12. The modeling apparatus of claim 11, wherein the connectivity information generation unit comprises:
a boundary detection unit detecting a boundary of the object; and
a grouping unit performing grouping on pixels which do not belong to the detected boundary of the object, among the pixels of the depth image, so that each pixel not belonging to the detected boundary of the object and adjacent pixels of the pixel are grouped into one group.

13. The modeling apparatus of claim 11, wherein the mesh generation unit generates one polygon by connecting the vertices corresponding to the pixels grouped into one group.

14. The modeling apparatus of claim 11, wherein the geometry information generation unit checks whether a difference in depth value between the vertices connected by the mesh generation unit is greater than or equal to a predetermined threshold value and selectively generates a vertex between the connected vertices according to the checked results, and the mesh generation unit updates the polygonal mesh in consideration of the selectively generated vertex.

15. The modeling apparatus of claim 14, wherein a difference in depth value between the connected vertices and the selectively generated vertex is smaller than the threshold value.

16. The modeling apparatus of claim 14, wherein the mesh generation unit updates the polygonal mesh by dividing at least part of the polygons in consideration of the selectively generated vertex.

17. The modeling apparatus of claim 11, wherein the mesh generation unit determines color information of each vertex in consideration of a color image that matches to the depth image.

18. The modeling apparatus of claim 11, further comprising a post-processing unit interpolating at least one of color information and geometry information for a hole that is located in the polygonal mesh to correspond to the boundary of the object, in consideration of at least one of color information and geometry information around the hole.

19. The modeling apparatus of claim 11, wherein the adjacent pixels belong to the non-boundary of the object.

20. The modeling apparatus of claim 11, wherein the connectivity information generation unit groups the pixels by three, and each polygon is a triangle.

21. A computer readable recording medium having embodied thereon a computer program for executing the method according to claim 1.
